(19) United States
(12) Patent Application Publication
(10) Pub. No.: US 2025/0083203 A1
(43) Pub. Date: Mar. 13, 2025

(54) SYSTEM AND METHOD FOR CONVEYING EFFLUENT FROM A TISSUE DIGESTER

(71) Applicant: Gateway Services Inc., Guelph (CA)

(72) Inventor: Martin Minajew, Guelph (CA)

(73) Assignee: Gateway Services Inc., Guelph, ON (CA)

(21) Appl. No.: 18/809,562

(22) Filed: Aug. 20, 2024

Related U.S. Application Data
(60) Provisional application No. 63/581,608, filed on Sep. 8, 2023.

(51) Int. Cl. B09B 3/70

(52) U.S. Cl. CPC B09B 3/70

(57) ABSTRACT

Disclosed herein are tissue digesters and methods of operation. In some examples, a tissue digester includes a fluid container having an upper region and a lower region; a first drain extending from within the fluid container at the lower region and in selective fluid communication with a first drain conduit; a second drain extending from within the fluid container at the upper region and associated with a second drain conduit; and a divider within the fluid container projecting from an inner sidewall of the fluid container from a first elevation at or beneath that of the second drain to a second elevation above the second drain thereby to form, with the inner sidewall, a trough, wherein fluid within the fluid container is permitted to enter the trough thereby to exit the second drain only when at least a level of the fluid in the fluid container exceeds the second elevation.

### CROSS-REFERENCE TO RELATED APPLICATIONS

This application claims priority to U.S. Provisional Patent Application Ser. No. 63/581,608 entitled “SYSTEM AND METHOD FOR CONVEYING EFFLUENTS FROM A TISSUE DIGESTER” filed on Sep. 8, 2023 under attorney docket number 100723-00005, the contents of which are incorporated herein by reference.

### FIELD OF THE INVENTION

The present disclosure relates generally to the disposal of remains, and more particularly to systems and methods for conveying effluent from a tissue digester.

### BACKGROUND OF THE INVENTION

Various methods of disposing of the remains of humans and animals are available. As common examples, remains may be buried, cremated/incinerated, or subjected to tissue digestion using an alkaline hydrolysis (AH) tissue digester.

Very generally speaking, an AH tissue digester contains a given set of remains and, while they are contained in a container, thoroughly exposes the remains to an alkaline liquid. Typically, the alkaline liquid includes water, sodium hydroxide, and potassium hydroxide in respective amounts, and is heated. The thorough exposure of the remains to the alkaline liquid facilitates the hydrolysis—or breakdown—of at least the soft tissue portions of the remains. AH tissue digestion may generally be regarded as a means by which the soft tissue portions of remains may be separated from bones and rendered as effluent: liquids, greasy droplets, small loose particulate and the like. Effluent is flowable, and thus may more easily be disposed of than the original, more solid, soft tissue.

It is common for AH tissue digestion to be conducted as a discrete process, in that a particular set of remains (i.e. a body or bodies) is maintained for a duration within a container along with alkaline liquid. For such a discrete process, a given body may first be placed within a respective cage, porous bag, or other structure within the container to facilitate total surface exposure of the body to the alkaline liquid and also to retain its bones together as a set, apart from any other bones or sets of bones. As AH tissue digestion occurs, fatty tissues and other constituents of the remains physically separate from the bones, break apart into smaller drops/globs, and thereafter pass out of any respective cage/bag. Due to their lower densities relative to other liquid, the more fatty/greasy constituents of the effluent tend to flow generally upwards, such that overall the effluent stratifies with the fatty/greasy constituents forming a greasy/slippery top stratum. After sufficient soft tissue digestion has occurred, all of the effluent may be drained from the bottom of the container and the bones removed for downstream processing.

While it is common to drain all of this effluent from the bottom of the container, one drawback to doing so is that, as the overall effluent level descends during draining, the greasy/slippery top stratum of the effluent descends as well. As it does so, it tends to drape over and coat objects with which it comes into contact. These objects may include the inner sidewalls and bottom of the container, the bones, any cages/bags containing bones, and any other objects in the container. The coating on the objects carries odors and can build up over time, increasing the need for more frequent maintenance and cleaning. The coating generally needs also to be removed from the bones themselves, which can discolor them, as well as lengthen their drying and preparation time. The coating is also easily transferred to surfaces outside of the container throughout a facility, presenting safety risks due to slipperiness, unpleasant odors, and accordingly increases the need for frequent cleaning that is difficult and time consuming to do effectively.

It is an object of an aspect of this disclosure to obviate or mitigate disadvantages set forth above.

### SUMMARY OF THE INVENTION

This description is directed to systems and methods for draining effluent from tissue digesters so as to reduce, as compared with existing systems and methods described above, contact between the greasy/slippery constituents of tissue digestion effluent and other objects within a tissue digester container.

In accordance with an aspect, there is provided a tissue digester comprising: a fluid container having an upper region and a lower region; a first drain extending from within the fluid container at the lower region and in selective fluid communication with a first drain conduit; a second drain extending from within the fluid container at the upper region and associated with a second drain conduit; and a divider within the fluid container projecting from an inner sidewall of the fluid container from a first elevation at or beneath that of the second drain to a second elevation above the second drain thereby to form, with the inner sidewall, a trough, wherein fluid within the fluid container is permitted to enter the trough thereby to exit the second drain only when at least a level of the fluid in the fluid container exceeds the second elevation.

By providing at least two drains, one of which extends from within the container at the upper region, and one of which extends from within the container at the lower region, the tissue digester enables effluent to be drained from both the upper region of the container and from the lower region. As with tissue digestion the effluent tends over time to stratify according to differential densities of the constituents of the effluent, this configuration enables the less dense but greasy/slippery stratum of effluent to be drained off of the top via the second drain, rather than traverse the container from top to bottom to be drained from the bottom. Draining at least some of the greasy/slippery stratum from the top of the effluent keeps the drained greasy/slippery stratum from draping over and coating objects within the container on its way to be drained from the bottom.

In practice, once alkaline hydrolysis itself has completed, and the effluent has at least somewhat stratified as explained above, the fluid level may be raised with the addition of more fluid and/or by displacement. As the fluid level is raised, the upper stratum itself—the greasy/slippery stratum—is pushed above the second elevation, where the greasy/slippery substance is thereafter permitted to enter the trough. Modulation of the fluid level can be conducted to urge the greasy/slippery substance into the trough without urging very much of the rest of the effluent below it into the trough; at least only as much as would facilitate mainly drainage through the second drain of the greasy/slippery stratum.

It may be appreciated that, if the fluid level during alkaline hydrolysis is such that it remains below the trough itself, thereafter raising the fluid level to drain the upper stratum of effluent also reduces the overall upper surface area of the effluent until the fluid exceeds the second elevation where it can “expand” into the trough. As will be appreciated, this is due to the presence, at that fluid level, of the divider itself extending within the container to form the trough. Reduction of the overall upper surface area at this fluid level may slightly compact the greasy/slippery substance until the fluid level exceeds the second elevation, at which point the greasy/slippery substance at that stratum can perhaps, to some extent, “spring” towards the trough. This compression-expansion effect may facilitate drainage of the greasy/slippery substance.

Testing has indicated that when the greasy/slippery stratum is drained “from above” in this manner, and thus kept from draping over and coating bones and any other objects in the container after the alkaline hydrolysis process, the bones are visibly whiter than prior techniques that had allowed substantially all of this greasy/slippery stratum to drape over the bones on its way towards the lowermost drain. That is, there is visibly less discoloration of the bones.

In an example, the divider projects obliquely from the inner sidewall. Such an angled projection of a planar surface may have various advantages. For example, as the fluid level is raised, a single planar surface comes into contact with a respective edge of the greasy/slippery stratum of the effluent. As contrasted with a more complex or longer divider, the single planar surface may be easier to clean following this contact.

In an alternative example, the trough is outside of the main interior of the fluid container. For example, the dividing wall may be the outer sidewall such that fluid is urged out of the main interior of the fluid container past the sidewall of the container into the trough.

In an example, the second drain may be in selective fluid communication with the second drain conduit.

In an example, the second drain may be in selective fluid communication with the second drain conduit via at least one of: a drain valve, a panel, a door.

In an example, the second drain is in open fluid communication with the second drain conduit.

In an example, the tissue digester further comprises at least one fluid inlet for selectively providing liquid into the container. In examples, alkaline liquid or other fluid, such as water, may simply be carefully poured into the top of the container or caused to enter into the container with a removable inlet such as a hose.

In an example, the second drain conduit is in fluid communication with the first drain conduit. In this example, the greasy/slippery substance and the other liquid of the effluent are reunited outside of the container as they are drained.

In an example, the first drain extends from a bottom wall of the fluid container. In alternative examples, the first drain may extend from a lowermost region of a sidewall of the container. Multiple additional drains serving as first and second drains may, in some examples, be provided.

In an example, the selective fluid communication of the first drain and the first drain conduit is provided by a first drain valve. In an example, wherein the selective fluid communication of the second drain and the second drain conduit is provided by a second drain valve. Such first and second drain valves may be manually operated or operated using an automation system. Alternatively, selective fluid communication of the first and/or second drains and their respective conduits may be provided by the insertion and removal of drain plugs.

In accordance with another aspect, there is provided a tissue digester comprising a fluid container having an upper region and a lower region; a first drain extending from within the fluid container at the lower region and in selective fluid communication with a first drain conduit; and a second drain associated with the upper region of the fluid container and associated with a second drain conduit, wherein fluid within the fluid container is permitted to exit the second drain only when at least a level of the fluid at the second drain is at least at an elevation of the second drain.

In an example, the tissue digester further comprises a trough associated with the upper region and having a dividing wall extending upwards at least from a first elevation to a second elevation at a top of the upper region, wherein the second drain extends from within the trough, wherein fluid within the fluid container is permitted to enter the trough thereby to cause the level of the fluid at the second drain to be at least at the elevation of the second drain only when a level of the fluid in the fluid container exceeds the second elevation.

In an example, the second drain is in selective fluid communication with the second drain conduit.

In an example, the second drain is in selective fluid communication with the second drain conduit via at least one of: a drain valve, a panel, a port.

In an example, the second drain is in open fluid communication with the second drain conduit.

In an example, the trough comprises an inner sidewall of the fluid container and the dividing wall projects from the inner sidewall from the first elevation to the second elevation.

In an example, the trough comprises an outer sidewall of the fluid container and the dividing wall is the outer sidewall.

In an example, the trough is on the inside of the fluid container.

In an example, the trough is on the outside of the fluid container.

In an example, the tissue digester further comprises at least one fluid inlet for selectively providing fluid into the fluid container.

In an example, the second drain conduit is in fluid communication with the first drain conduit.

In an example, the first drain extends from a bottom wall of the fluid container.

In an example, the selective fluid communication of the first drain and the first drain conduit is provided by a first drain valve.

In an example, the selective fluid communication of the second drain and the second drain conduit is provided by a second drain valve.

In accordance with an aspect, there is provided a method of operating a tissue digester comprising: initiating a tissue digestion by submerging at least remains within an alkaline liquid within the fluid container, wherein a fluid level of the alkaline liquid and resulting effluent during the tissue digestion remains below the second elevation; after at least some tissue digestion, causing the fluid level of the effluent to rise to above the second elevation thereby to permit an upper stratum of the effluent to enter into the trough; and after permitting the upper stratum of the effluent to enter into the trough, draining a remainder of the effluent via the first drain.

In an example, the method further comprises draining the upper stratum of the effluent via the second drain.

In an example, draining the upper stratum of the effluent via the second drain comprises draining the upper stratum of the effluent via the second drain simultaneously with the draining of a remainder of the effluent via the first drain.

In an example, draining the upper stratum of the effluent via the second drain comprises draining the upper stratum of the effluent via the second drain before the draining of a remainder of the effluent via the first drain.

In an example, draining the upper stratum of the effluent via the second drain comprises draining the upper stratum of the effluent via the second drain after the draining of a remainder of the effluent via the first drain.

In an example, a liquid level of the alkaline liquid and the resulting effluent during the tissue digestion remains below the first elevation.

In accordance with another aspect, there is provided a method of operating a tissue digester comprising: initiating a tissue digestion by submerging at least remains within an alkaline liquid within the fluid container thereby to produce an effluent; after at least some tissue digestion, causing an upper stratum of the effluent to enter into the second drain; and after permitting the upper stratum of the effluent to enter into the second drain, draining a remainder of the effluent via the first drain.

In an example, a liquid level of the alkaline liquid and the resulting effluent during the tissue digestion remains below the elevation of the second drain, wherein causing the upper stratum of the effluent to enter into the second drain comprises: causing the fluid level of the effluent to rise to at least the elevation of the second drain.

In examples, it may be useful to cause the liquid level of effluent to rise one or more times during tissue digestion itself, rather than solely after tissue digestion is complete, so as to drain the upper stratum multiple times. This may be useful if the greasy/slippery stratum becomes thick during tissue digestion, to reduce the chance of the stratum, as it thickens progressively downwards due to progressive tissue digestion, from coming into contact with objects within the container even before tissue digestion is complete.

### BRIEF DESCRIPTION OF THE FIGURES

Examples will now be described with reference to the figures, in which:

FIG. 1 is a cross-sectional front view of a tissue digester containing baskets and a level of effluent after at least some alkaline hydrolysis of the contents of the baskets has occurred, according to the prior art;

FIG. 2 is a cross-sectional side view of the tissue digester with the level of effluent as shown in FIG. 1, according to the prior art;

FIG. 3 is a cross-sectional front view of the tissue digester of FIG. 1 and a lower level of effluent than that shown in FIG. 1, according to the prior art;

FIG. 4 is a cross-sectional side view of the tissue digester with the level of effluent as shown in FIG. 3, according to the prior art;

FIG. 5 is a cross-sectional front view of the tissue digester of FIG. 1 and a lower level of effluent than that shown in FIG. 3, according to the prior art;

FIG. 6 is a cross-sectional side view of the tissue digester with the level of effluent as shown in FIG. 5, according to the prior art;

FIG. 7 is a cross-sectional front view of the tissue digester of FIG. 1 with the level of effluent at its lowest, but with some greasy/slippery effluent that had been draped over the baskets having to be cleaned off, according to the prior art;

FIG. 8 is a cross-sectional front view of the tissue digester of FIG. 1 with the level of effluent at its lowest and with the greasy/slippery effluent having been cleaned off, according to the prior art;

FIG. 9 is a cross-sectional front view of a tissue digester according to an example, containing baskets and a level of effluent after at least some alkaline hydrolysis of the contents of the baskets has occurred;

FIG. 10 is a cross-sectional side view of the tissue digester of FIG. 9 with the level of effluent as shown in FIG. 9;

FIG. 11 is a cross-sectional front view of the tissue digester of FIG. 9 with a higher level of effluent than that shown in FIG. 9;

FIG. 12 is a cross-sectional side view of the tissue digester of FIG. 9 with the level of effluent as shown in FIG. 11;

FIG. 13 is a cross-sectional front view of the tissue digester of FIG. 9 with a higher level of effluent than that shown in FIG. 12;

FIG. 14 is a cross-sectional side view of the tissue digester of FIG. 9 with the level of effluent as shown in FIG. 13;

FIG. 15 is a cross-sectional front view of the tissue digester of FIG. 9 with about half of a greasy/slippery stratum of the effluent having been urged into a trough;

FIG. 16 is a cross-sectional side view of the tissue digester of FIG. 9 with the level of effluent as shown in FIG. 15;

FIG. 17 is a cross-sectional front view of the tissue digester of FIG. 9 with about all of the greasy/slippery stratum of the effluent having been urged into the trough;

FIG. 18 is a cross-sectional side view of the tissue digester of FIG. 9 with the level of effluent as shown in FIG. 17;

FIG. 19 is a cross-sectional front view of the tissue digester of FIG. 9 with a lower level of effluent, and also including very little or none of the greasy/slippery stratum due to it having been urged into the trough;

FIG. 20 is a cross-sectional side view of the tissue digester of FIG. 9 with the level of effluent as shown in FIG. 19;

FIG. 21 is a cross-sectional front view of the tissue digester of FIG. 9 with a lower level of effluent than that shown in FIG. 19;

FIG. 22 is a cross-sectional side view of the tissue digester of FIG. 9 with the level of effluent as shown in FIG. 21;

FIG. 23 is a cross-sectional front view of the tissue digester of FIG. 9 with the level of effluent at its lowest and with very little or none of the greasy/slippery stratum of effluent having been draped over the basket;

FIG. 24 is a cross-sectional side view of the tissue digester of FIG. 9 with the level of effluent as shown in FIG. 23; and

FIG. 25 is a cross-sectional side view of a tissue digester, according to an alternative example in which a trough is substantially outside of the interior of the fluid container, and showing a level of effluent at which a greasy/slippery stratum of the effluent is beginning to be urged outside of the fluid container and into the trough.

### DETAILED DESCRIPTION

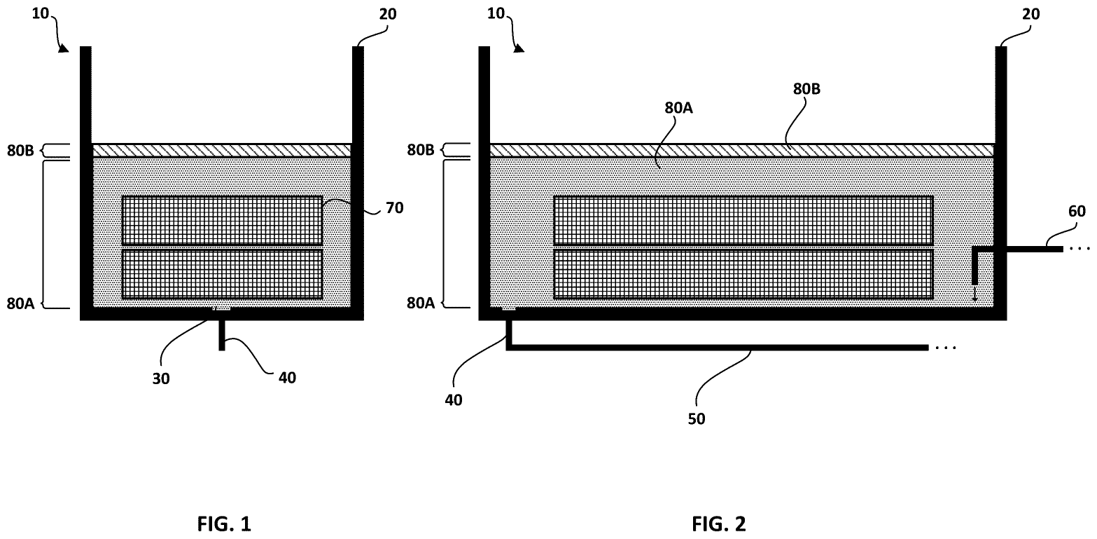

FIG. 1 is a cross-sectional front view of a tissue digester 10, according to the prior art. FIG. 2 is a cross-sectional side view of tissue digester 10 with the level of effluent as shown in FIG. 1.

Tissue digester 10 includes a fluid container 20 that is sized to contain at least one basket 70, which itself will contain remains for a digestion process, as well as the alkaline liquid that is introduced into the fluid container 20 to break down the remains. Fluid container 20 has an upper region and a lower region, the distinction between the upper and lower regions being generally that the lower region extends from the bottom of the interior of fluid container 20 to above, for example just above, the level at which the at least one basket 70 extends, and the upper region extends from the top of the lower region to the top of fluid container 20.

As shown in FIG. 1, tissue digester 10 includes a first drain 30 extending from within fluid container 20 at the lower region, in this example from the bottom wall of fluid container 20. First drain 30 is in selective fluid communication, by way of a first drain valve 40, with a first drain conduit 50.

In this example, a single fluid inlet 60 conveys fluid, such as water or other fluid(s), into the interior of fluid container 20 thereby to raise the level of fluid inside of fluid container 20.

In the state shown in FIGS. 1 and 2, at least some alkaline hydrolysis of the contents of basket 70 has occurred, such that the remains have been at least partly broken down. While effluent within the fluid container 20 when initially introduced (for example, via fluid inlet 60 or by introduction into fluid container 20 in another way) was primarily solely an alkaline liquid that is a single substance or a solution, at least some alkaline hydrolysis of the remains within basket 70 has occurred. This has led over some time to the effluent being stratified such that the effluent has formed into a dense stratum 80A of primarily the alkaline liquid, and a less dense stratum 80B that is more greasy/slippery than dense stratum 80A. While in reality there may not be as sharp a visual distinction between the strata 80A, 80B as being shown in the Figures, it is the differences in densities of the materials produced as a result of alkaline hydrolysis that cause the greasy/slippery materials to rise through stratum 80A and collect to form stratum 80B atop stratum 80A.

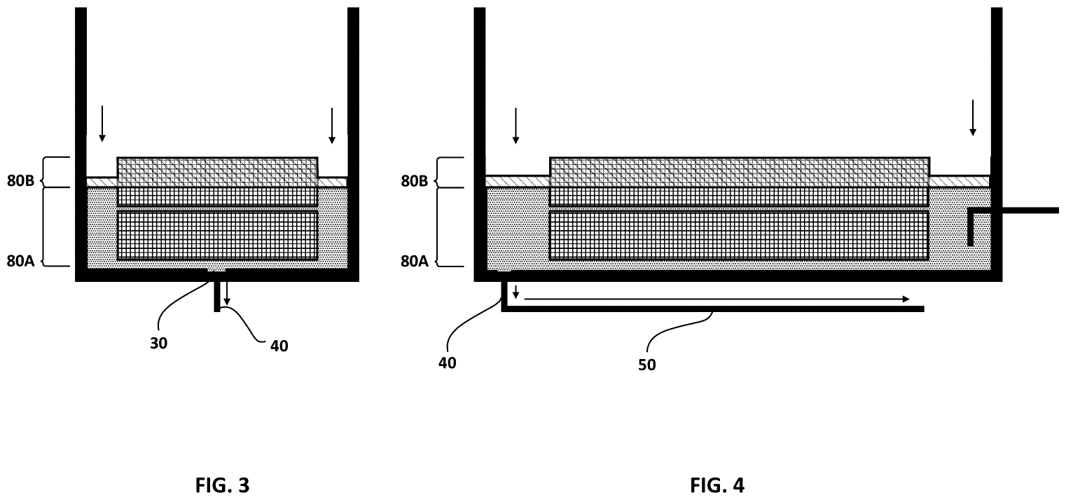

FIG. 3 is a cross-sectional front view of tissue digester 10 with a lower level of effluent in fluid container 20 than that shown in FIG. 1, and FIG. 4 is a cross-sectional side view of tissue digester 10 with the level of effluent as shown in FIG. 3. The lower level of effluent has resulted from draining, through first drain 3 at the bottom of fluid container 20, when opening first drain valve 40, into first drain conduit 50, a certain amount of the effluent. The drained effluent is being discarded and/or treated in a manner appropriate to the ecological authorities. However, stratum 80B, as stratum 80A has progressively drained, has come from above onto basket and has draped atop of basket 70. Due to its greasy/slippery nature, stratum 80B has at least partially remained on basket 70, coating it with greasy/slippery material. Also, because stratum 80B has passed along the interior walls of fluid container 20 on its way downward, it may have provided a greasy/slippery coating along the interior walls.

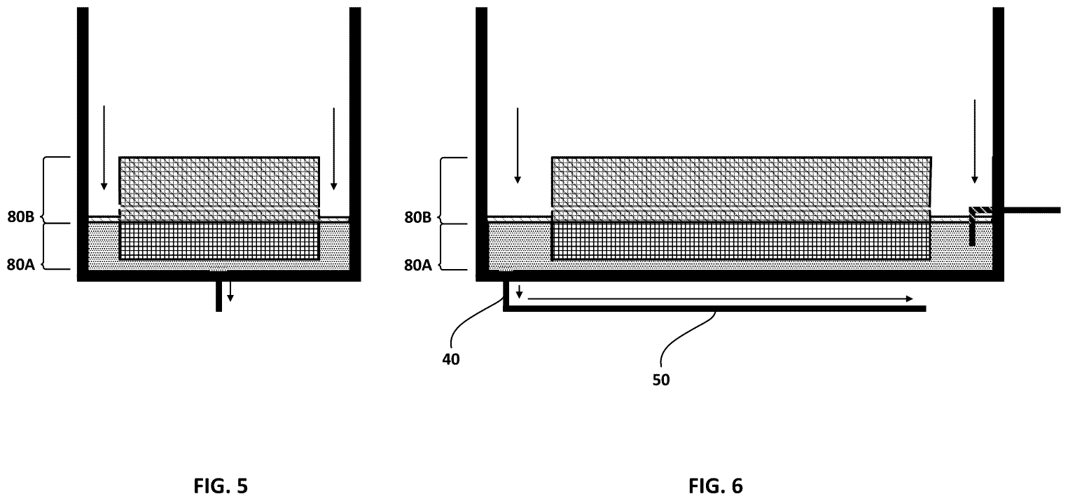

FIG. 5 is a cross-sectional front view of tissue digester 10 and a lower level of effluent than that shown in FIG. 3, and FIG. 6 is a cross-sectional side view of tissue digester 10 with the level of effluent as shown in FIG. 5. As stratum 80A has continued to drain, stratum 80B has settled further atop and around basket 70 as well as an interior portion of fluid inlet 60, coating basket 70 and this portion of fluid inlet with the greasy/slippery effluent. While some of the greasy/slippery effluent of stratum 80B may exit first drain 30, due to its properties it is likely to have, by this time, coated the interior sidewalls of fluid container 20, basket 70, fluid inlet 60, the bottom wall of fluid container 20, and portions of first drain 30. The greasy/slippery effluent will also have similarly draped over and coated the remaining contents of the baskets, for example the bones remaining after the alkaline hydrolysis.

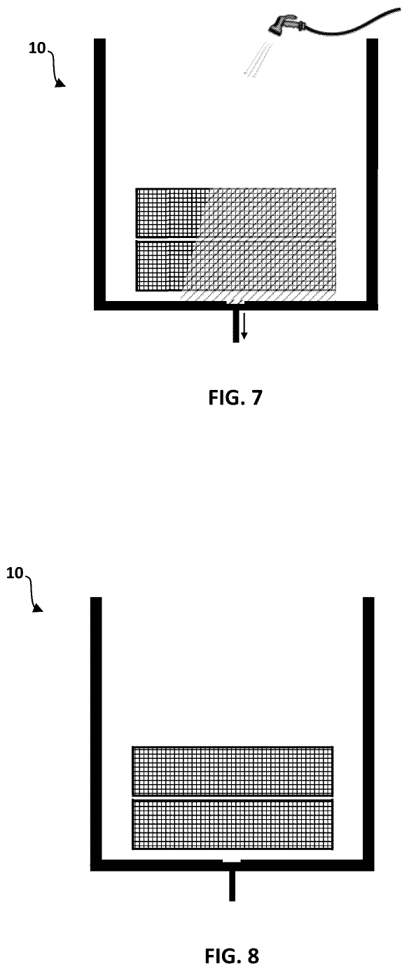

FIG. 7 is a cross-sectional front view of tissue digester 10 with the level of effluent at its lowest, but showing some greasy/slippery effluent that had been draped over basket 70 having to be cleaned off, as represented by the hose and nozzle shown. FIG. 8 is a cross-sectional front view of tissue digester 10 with the level of effluent at its lowest and with the greasy/slippery effluent having been cleaned off. It will be appreciated that the greasy/slippery effluent can have an unpleasant odor, and that it may require grease-cutting detergents and several rinses to remove from that with which it has come into contact. This cleaning is time consuming and can be costly due to the extra steps and/or materials for cleaning that may be required after each alkaline hydrolysis procedure, or otherwise periodically.

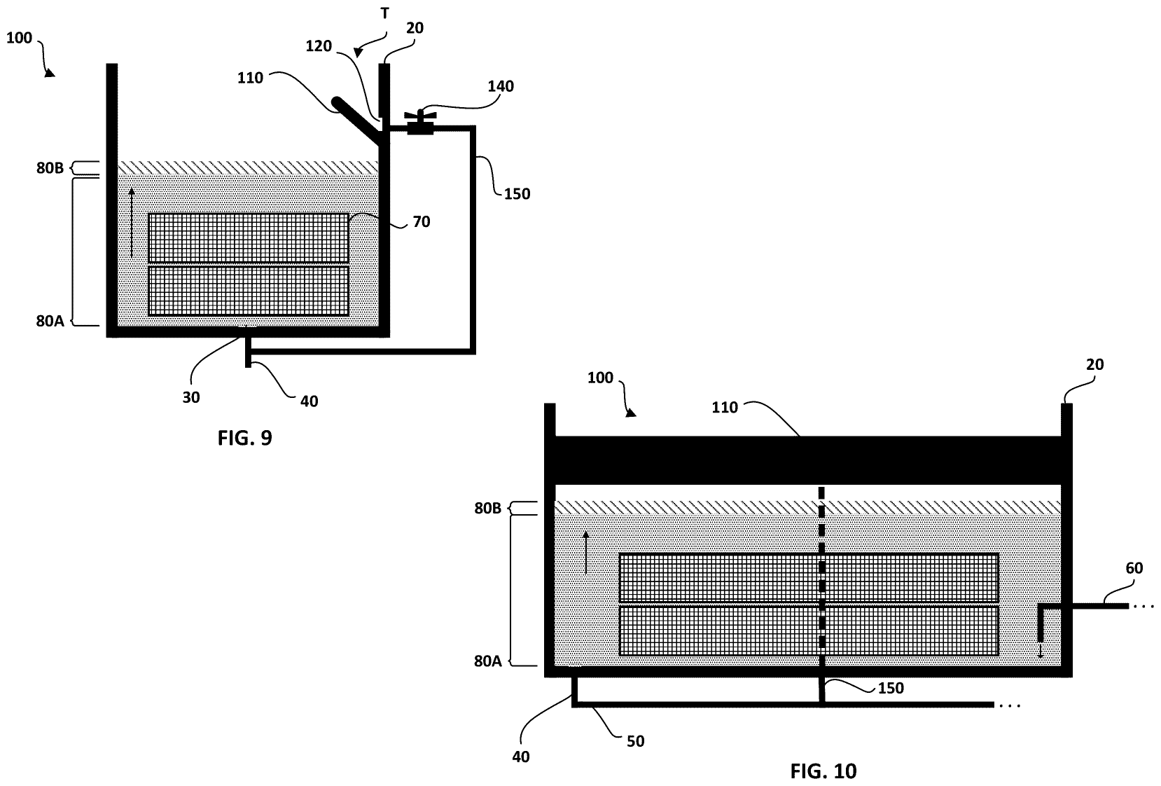

FIG. 9 is a cross-sectional front view of a tissue digester 100, according to an example, containing a basket 70 and a level of effluent, including strata 80A, 80B, after at least some alkaline hydrolysis of the contents of basket 70 has occurred. FIG. 10 is a cross-sectional side view of the tissue digester of FIG. 9 with the level of effluent as shown in FIG. 9. In this example, tissue digester 100 includes a fluid container 20 that is sized to contain at least one basket 70, which itself will contain remains for a digestion process, as well as the alkaline liquid that is introduced into the fluid container 20 to break down the remains. Fluid container 20 has an upper region and a lower region, the distinction between the upper and lower regions being generally that the lower region extends from the bottom of the interior of fluid container 20 to above, for example just above, the level at which the at least one basket 70 extends, and the upper region extends from the top of the lower region to the top of fluid container 20. Tissue digester 10 includes a first drain 30 extending from within fluid container 20 at the lower region, in this example from the bottom wall of fluid container 20. First drain 30 is in selective fluid communication, by way of a first drain valve 40, with a first drain conduit 50. In this example, a single fluid inlet 60 conveys fluid, such as water or other fluid(s), into the interior of fluid container 20 thereby to raise the level of fluid inside of fluid container 20.

In this example, a second drain 120 extends from within fluid container 20 at the upper region, and is in selective fluid communication with a second drain conduit 150, via a second drain valve 140 (or “effluent by-pass valve”). In this example, second drain conduit 150 is in fluid communication with first drain conduit 50. A divider 110 within fluid container 20 projects from an inner sidewall of fluid container 20 from a first elevation that is at or beneath that of the elevation of second drain 120 to a second elevation that is above second drain 120. Divider 110 extends the entire length of the wall with which it is associated, and projects at an angle to form a bottom-facing ramp to reduce the entrapment of greasy/slippery substance. With this section of the inner sidewall, divider 110 forms a trough T that drains into second drain 120. As the effluent level shown in FIGS. 9 and 10 is below the second elevation, none of strata 80A, 80B has risen to an elevation at which it can begin to flow into the trough.

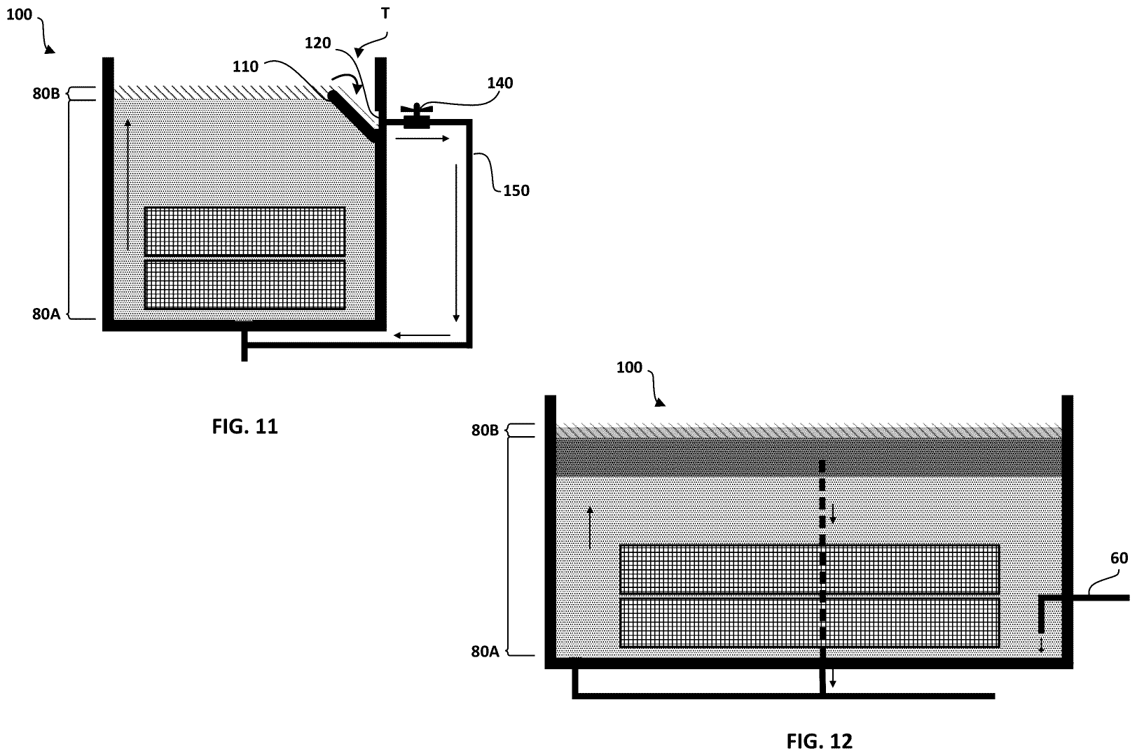

FIG. 11 is a cross-sectional front view of tissue digester 100 with a higher level of effluent than that shown in FIG. 9, and FIG. 12 is a cross-sectional side view of tissue digester 100 with the level of effluent as shown in FIG. 11. Fluid, such as water, has been caused to enter into fluid container 20 (via fluid inlet 60 in the lower region, in this case), causing the level of effluent to rise. Also, second drain 120 is open to second drain conduit 150 as second drain valve 140 has been opened. Stratum 80B of the effluent has reached an elevation that slightly exceeds the second elevation to which divider 110 extends, and thus the greasy/slippery substance of stratum 80B is permitted to enter into the trough, thereby to exit fluid container 20 via second drain 120, open second drain valve 140, and second drain conduit 150. In this way, tissue digester 100 allows stratum 80B, and thus the bulk of the greasy/slippery substance formed from alkaline hydrolysis, to exit fluid container 20 at the top of its upper region, rather than requiring it to exit fluid container 20 at the bottom after having been draped over contents and the interior of fluid container 20 on its way downwards. The bulk of the greasy/slippery substance of stratum 80B therefore can exit fluid container 20 before the overall effluent level is brought downwards. As such, the features and configurations described herein that permit stratum 80B to exit without substantially passing to and through the lower region of fluid container 20, may be regarded as providing an effluent by-pass subsystem.

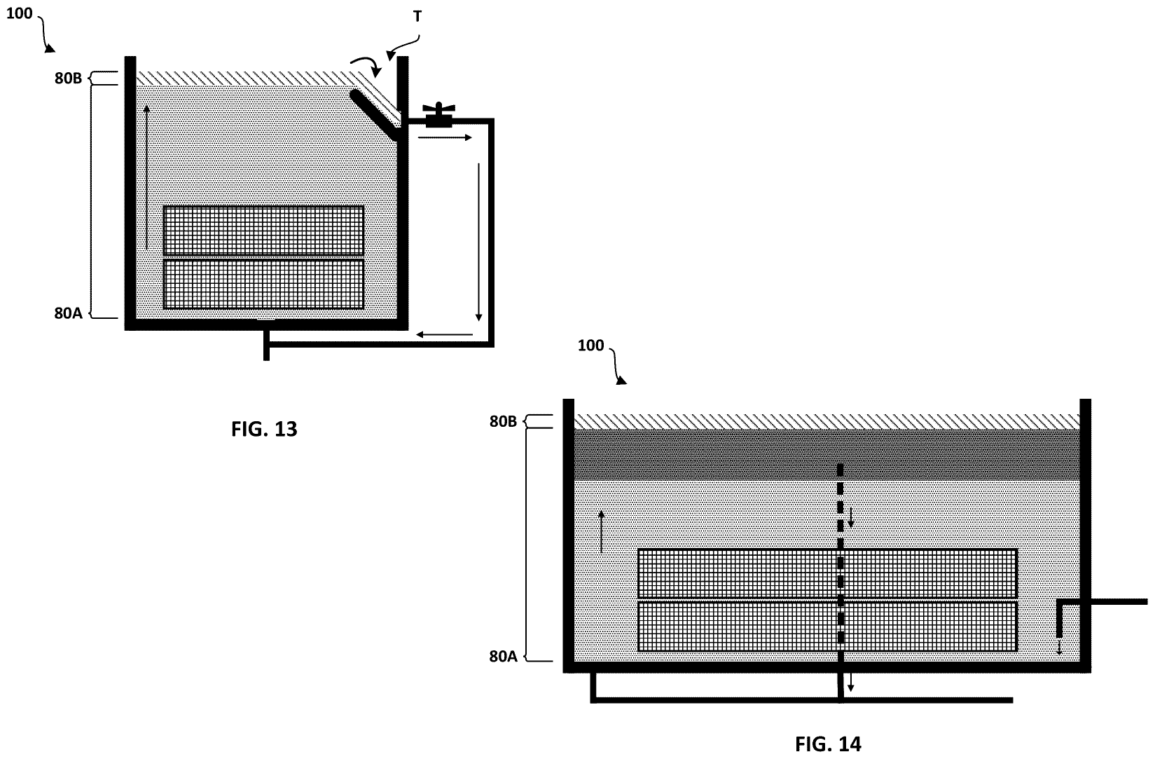

FIG. 13 is a cross-sectional front view of tissue digester 100 with a higher level of effluent than that shown in FIG. 12, and FIG. 14 is a cross-sectional side view of tissue digester 100 with the level of effluent as shown in FIG. 13. As the effluent level is increased more of the greasy/slippery stratum 80B of the effluent can be permitted to enter into the trough past divider 110 and thus exit fluid container 20.

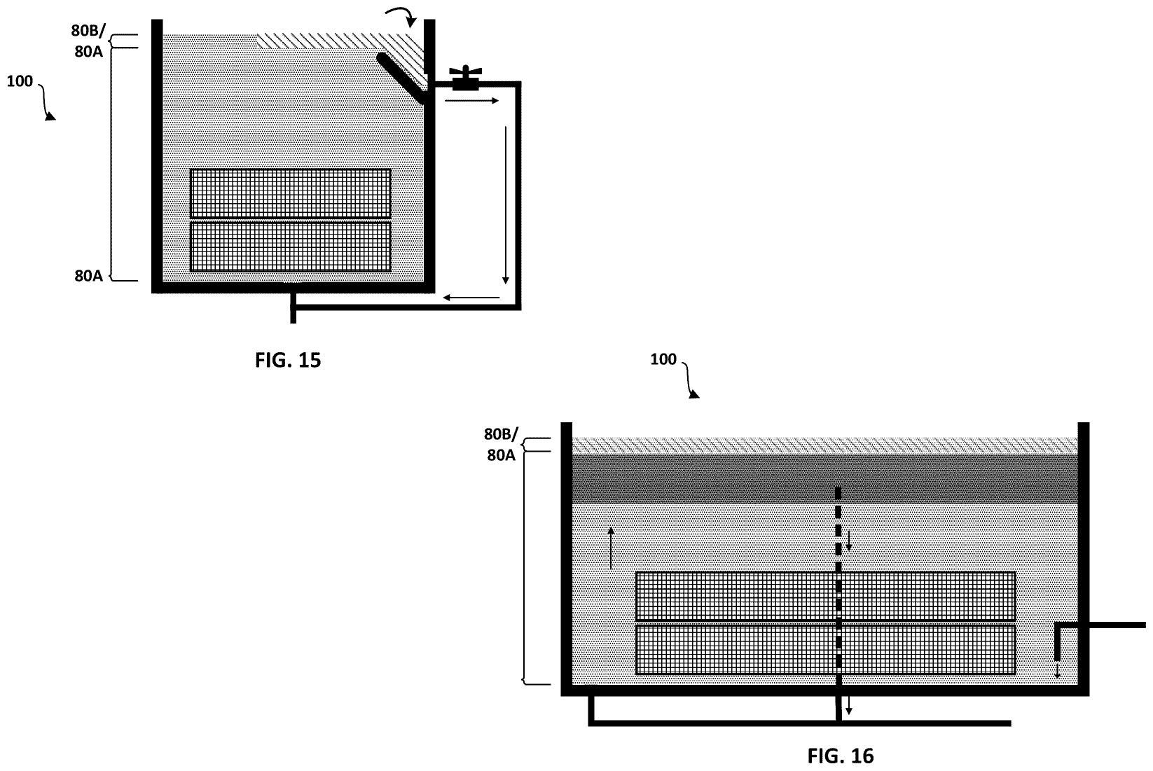

FIG. 15 is a cross-sectional front view of tissue digester 100 with about half of the greasy/slippery stratum 80B of the effluent having been urged into the trough. This is labelled in FIG. 15 as 80B/80A. FIG. 16 is a cross-sectional side view of tissue digester 100 with the level of effluent as shown in FIG. 15. As the effluent level is caused to rise, stratum 80B progressively exits along with a top portion of stratum 80A into trough, and stratum 80B within fluid container 20 generally shrinks in amount.

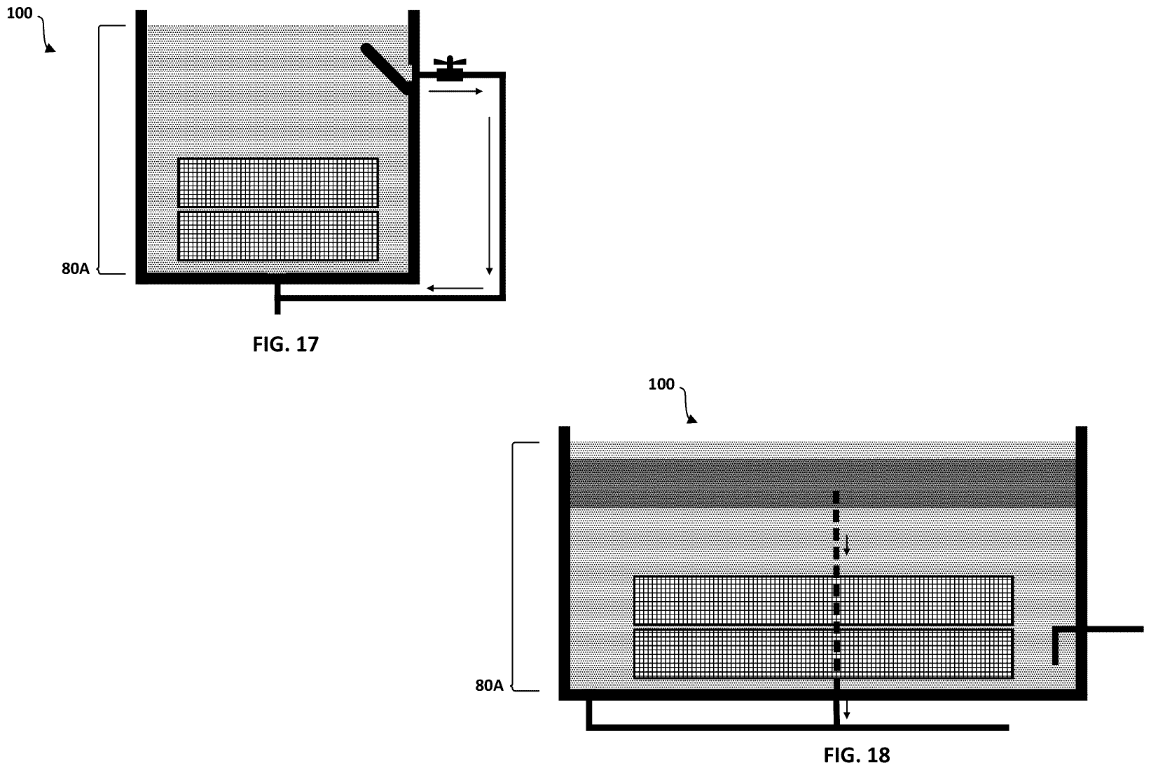

FIG. 17 is a cross-sectional front view of tissue digester 100 with about all of the greasy/slippery stratum 80B of the effluent having been urged into the trough, and FIG. 18 is a cross-sectional side view of tissue digester 100 with the level of effluent as shown in FIG. 17. At this time, with substantially all of stratum 80B having been permitted to enter the trough thereby to exit second drain 120, and with perhaps some of stratum 80A now exiting second drain 120 (for example, purposively chasing stratum 80B in order to aid with the full expulsion of stratum 80B from fluid container 20 and from second drain 120, second drain valve 140, and second drain conduit 150) addition of fluid via fluid inlet 60 may be stopped.

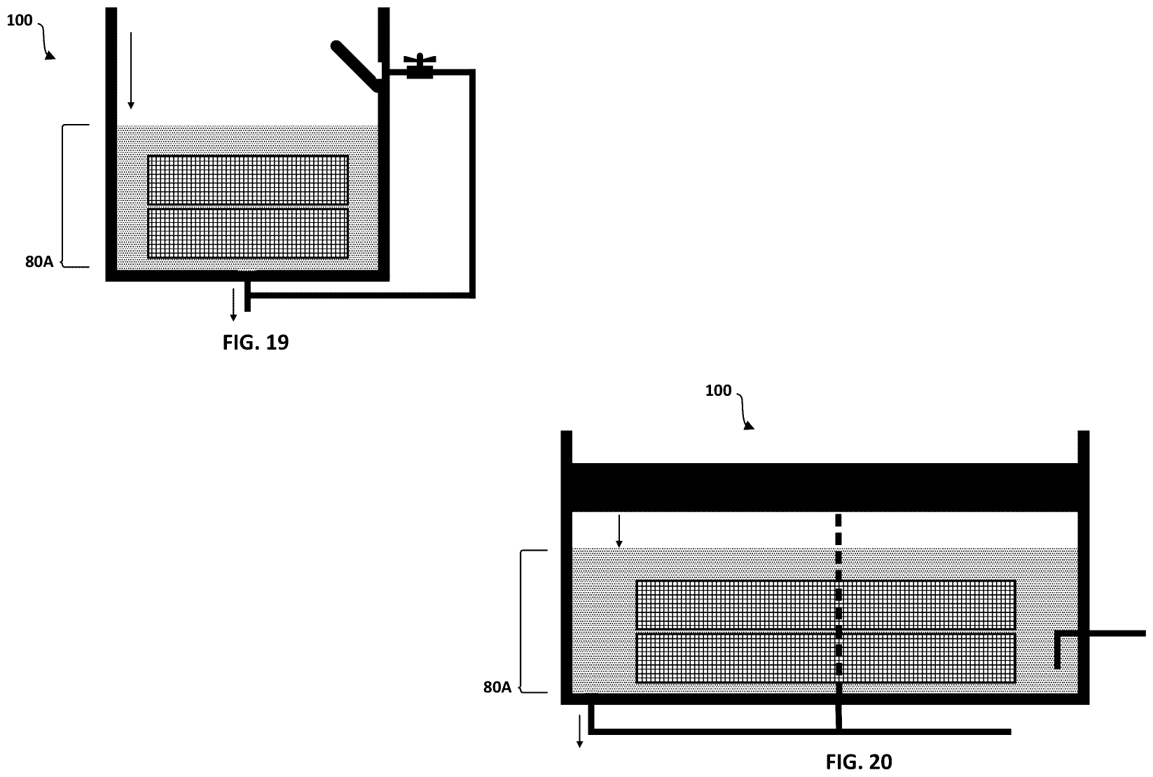

FIG. 19 is a cross-sectional front view of tissue digester 100 with a lower level of effluent due to draining via first drain 30, and also including very little or none of the greasy/slippery stratum 80B due to it having been already urged into the trough. It will be appreciated that, with stratum 80B having been significantly drained via the trough from fluid container 20, there is far less greasy/slippery substance being brought downwards along the interior walls of fluid container 20, to drape over basket 70 and its contents, and to drape over the bottom wall of fluid container 20. As such, less or less frequent cleaning of tissue digester 100 and contained baskets is required, and the contents of baskets 70—such as remaining bones—are coated less with greasy/slippery substance and can thus be dried and otherwise processed more readily for the subsequent stages.

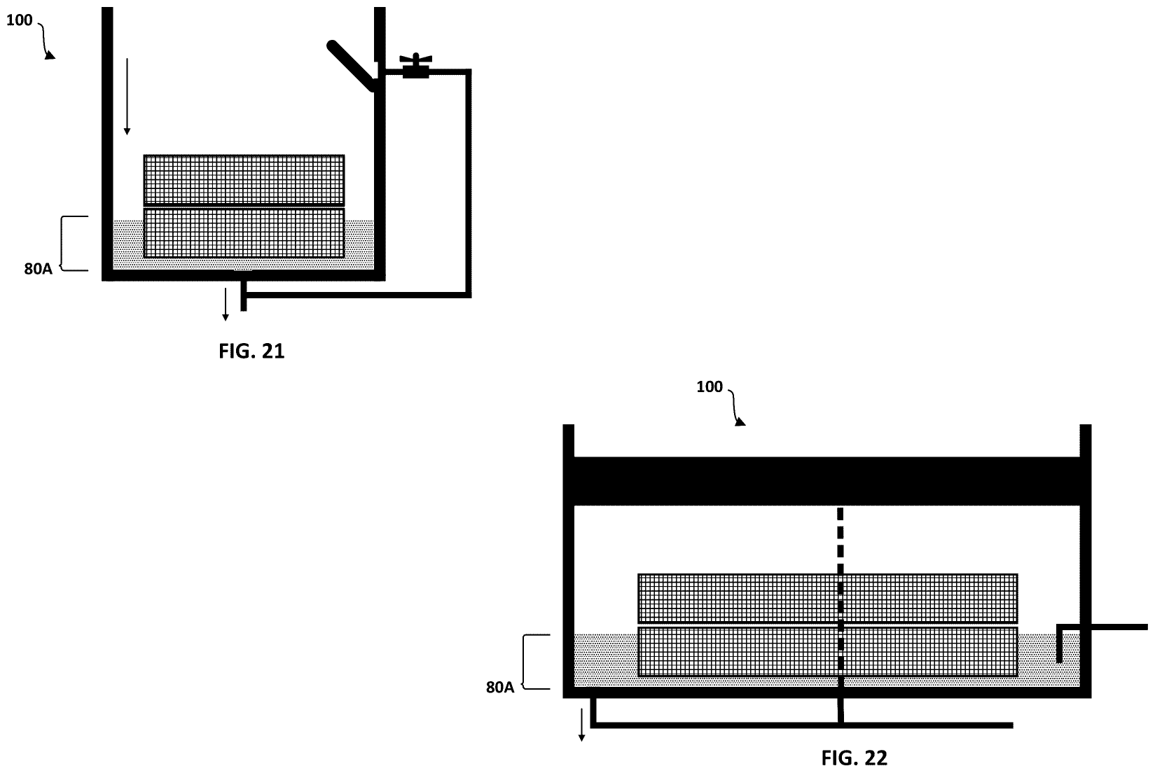

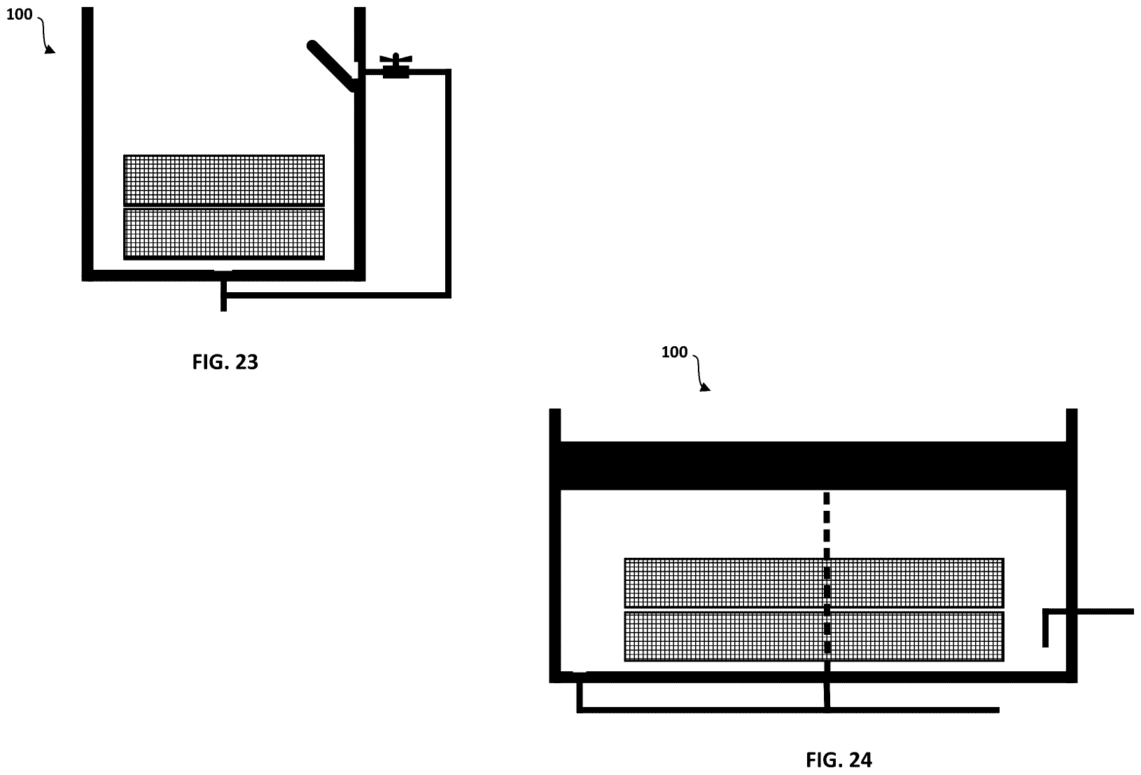

FIG. 20 is a cross-sectional side view of tissue digester 100 with the level of effluent as shown in FIG. 19. FIG. 21 is a cross-sectional front view of tissue digester 100 with a lower level of effluent than that shown in FIG. 19, and FIG. 22 is a cross-sectional side view of tissue digester 100 with the level of effluent as shown in FIG. 21. FIG. 23 is a cross-sectional front view of tissue digester 100 with the level of effluent at its lowest and with very little or none of the greasy/slippery stratum 80B of effluent having been draped over basket 70 and other portions of, or within, the interior of fluid container 20. FIG. 24 is a cross-sectional side view of tissue digester 100 with the level of effluent as shown in FIG. 23.

While examples have been described, alternatives are possible. For example, while in the examples shown herein a trough is formed from a divider extending inwardly from an interior wall of the fluid container, such that the trough is generally within the interior of the fluid container, it is possible to arrange a trough to be outside of the interior of the fluid container, such that the divider is the exterior wall of the fluid container and an element extends from the exterior wall to form, with the exterior wall of the fluid container, the trough. More generally, therefore, a tissue digester according to the invention may be described as including a trough associated with the upper region of the fluid container and having a dividing wall extending upwards at least from a first elevation to a second elevation at the top of the upper region, wherein the second drain extends from within the trough. In a particular example of this, the trough may comprise an inner sidewall of the container and the dividing wall or divider projects from the inner sidewall from the first elevation to the second elevation. In an alternative example of this, the trough may include an outer sidewall of the container and the dividing wall is the outer sidewall itself. That is, the trough may be on the inside or on the outside of the fluid container. In alternative examples, troughs may be formed on both the inside and the outside of the container, and/or may be formed along multiple of the walls of the fluid container instead of just one.

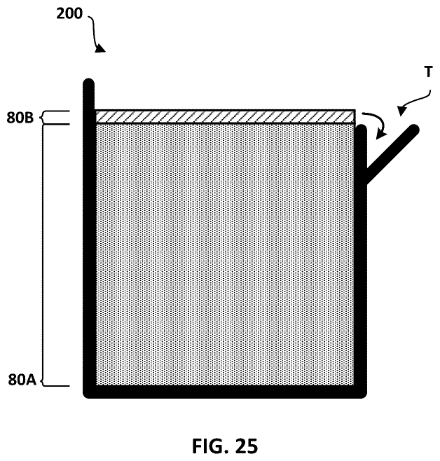

For example, FIG. 25 is a cross-sectional side view of a tissue digester 200, according to an alternative example in which a trough T is substantially outside of the interior of the fluid container 20, and showing a level of effluent at which a greasy/slippery stratum 80B above a lower stratum 80A of the effluent is beginning to be urged outside of the fluid container and into the exterior trough.

A method of operating a tissue digester, such as tissue digester 100 or tissue digester 200, according to an example, may include initiating tissue digestion by submerging at least remains within an alkaline liquid within the fluid container 20, wherein a fluid level of the alkaline liquid and resulting effluent during tissue digestion remains below the second elevation. This may be done by placing the remains in basket 70, filling fluid container 20 with heated water (95% by volume) and adding potassium hydroxide or sodium hydroxide (5% by volume). After at least some tissue digestion in which the hydroxide breaks bonds in the remains and forms the upper and lower strata 80A, 80B of effluent and leaving bone fragments inside basket 70, the liquid level of the effluent may be caused to rise to above the second elevation thereby to permit the upper stratum 80B of the effluent to enter into the trough T. After permitting the upper stratum 80B of the effluent to enter into the trough T, the remainder of the effluent may be drained via the first drain 30.

In examples, the upper stratum 80B of the effluent may be drained via second drain 120. Draining the upper stratum 80B of the effluent via second drain 120 may include draining the upper stratum 80B of the effluent via second drain 120 simultaneously with the draining of the remainder of the effluent (the lower stratum 80B) via the first drain. Draining the upper stratum 80B of the effluent via second drain 120 may include draining the upper stratum 80B of the effluent via second drain 120 before the draining of the remainder of the effluent (the lower stratum 80A) via first drain 30. Draining the upper stratum 80B of the effluent via second drain 120 may include draining the upper stratum 80B of the effluent via second drain 120 after the draining of the remainder of the effluent via the first drain 30.

In examples, a liquid level of the alkaline liquid and the resulting effluent during tissue digestion remains below the first elevation.

It is contemplated that prior art tissue digesters having a first drain towards the bottom of a container may be retrofitted so as to further include a second drain and a trough, as has been described in examples herein, and operation of such retrofitted tissue digesters may accord with methods of operation described herein. A kit for retrofitting a prior art tissue digester in accordance with the present description may include one or more of: a divider of a predetermined length corresponding to a particular model of prior art tissue digester, a mechanism and/or adhesive for attaching the divider to an inner sidewall of the prior art tissue digester thereby to form the trough with the inner sidewall, material for forming the second drain conduit, material such as plumbing connectors for bringing the second drain conduit into fluid communication with the first drain conduit, plugs and/or valves, automation electronics for use for sequential or simultaneous draining of effluent from the first and second drains, instructions for placement and formation of the second drain, instructions showing options for draining effluent from the second drain and/or plumbing the first and second drain conduits together, instructions for modified operation of a retrofitted prior art tissue digester, and the like.

While examples of a tissue digester described to this point involve a trough that is within a fluid container and has a divider wall to separate the trough from the rest of the interior of the fluid container, alternatives are possible. For example, a trough could be associated with the upper region of the fluid container, but be positioned, in the main at least, outside of the fluid container such that the divider, or dividing wall, that rises from at least the first elevation to the second elevation is an outer wall of the fluid container itself, and the outer trough wall would be formed by an additional element extending from the outer sidewall. With such an example, as an upper stratum of the effluent rises above the second elevation, and thus above the outer sidewall, it can drain past the outer sidewall and into the trough.

Where the trough is to be outside of the interior of the fluid container, a kit for retrofitting a prior art tissue digester in accordance with the present description may include one or more of: an outer trough wall of a predetermined length, such as the length of the divider described herein, corresponding to a particular model of prior art tissue digester, a mechanism and/or adhesive for attaching the trough wall to an outer sidewall of the prior art tissue digester thereby to form the trough with the outer sidewall, material for forming the second drain conduit, material such as plumbing connectors for bringing the second drain conduit into fluid communication with the first drain conduit, plugs and/or valves, automation electronics for use for sequential or simultaneous draining of effluent from the first and second drains, instructions for placement and formation of the second drain, instructions showing options for draining effluent from the second drain and/or plumbing the first and second drain conduits together, instructions for modified operation of a retrofitted prior art tissue digester, and the like.

While examples given herein are particularly useful configurations for retrofitting existing tissue digesters or for building new and useful tissue digesters that in many respects are similar in size and configuration as those presently available, with the exception of the inventive aspects described herein, alternatives are possible. For example, rather than forming a dividing wall that delincates a trough from the interior of the fluid container, and increasing the level of fluid to exceed that of the elevation of the top of the trough, exit of an upper stratum of effluent may be conducted without a trough by way of one or more moveable (i.e., slideable or pivotable or otherwise movable between positions) panel(s) or door(s) that, in one configuration, align with the wall of the fluid container to block exit of any effluent past the panel(s) or door(s) and that, in another configuration (after sliding, pivoting, or some other movement), selectively provide an opening in the wall or at the top of the wall of the fluid container, past the panel(s) or door(s), thereby to selectively cause the second drain to be in fluid communication with the second drain conduit and permit the upper stratum of effluent to exit from within the fluid container. Such panel(s) or door(s) may be at an elevation at which an upper stratum of greasy/slippery substance is expected to sit after at least some alkaline hydrolysis has occurred. Then, once the upper stratum of effluent is permitted sufficiently to exit, such panel(s) or door(s) may be selectively moved back to its/their original configuration in which exit of effluent past the panel(s) or door(s) is again blocked. Such an opening out of the fluid container may thereby be in selective fluid communication with a second drain conduit and form, in effect, a funnel to channel effluent towards second drain conduit in a similar manner as trough channels or funnels effluent in the embodiments described herein. Alternatively, such an opening out of the fluid container may be in open fluid communication with and serve as the second drain but be positioned in the upper region at an elevation that is normally sufficiently above the fluid level during alkaline hydrolysis to prevent exit of very much liquid until the fluid level has been caused to rise to bring the level of the fluid at such a second drain—preferably the greasy/slippery stratum at this level—to be at least at the elevation of the second drain so that the greasy/slippery stratum is caused to exit the second drain. Examples that include a trough or trough-like configuration are useful for enabling greasy/slippery substance to exit the main interior of the fluid container reasonable quickly such that the fluid level in the fluid container, once a desired amount of the greasy/slippery substance has entered into the trough, can be dropped below the second elevation, even if the greasy/slippery substance that has entered the trough has not fully exited the trough itself via the second drain. It may be the case that, a higher viscosity of greasy/slippery substance in the upper stratum than that in the lower stratum may take longer to exit the second drain after entering into the trough, such that the trough provides a region in which the greasy/slippery substance can be isolated from the remainder of the fluid container if it is desired to lower the effluent level in the remainder of the fluid container below the second elevation. Variations are possible.

### CLAUSES

### Clause 1.

A tissue digester comprising:

a fluid container having an upper region and a lower region;

a first drain extending from within the fluid container at the lower region and in selective fluid communication with a first drain conduit;

a second drain extending from within the fluid container at the upper region and associated with a second drain conduit; and

a divider within the fluid container projecting from an inner sidewall of the fluid container from a first elevation at or beneath that of the second drain to a second elevation above the second drain thereby to form, with the inner sidewall, a trough,

wherein fluid within the fluid container is permitted to enter the trough thereby to exit the second drain only when at least a level of the fluid in the fluid container exceeds the second elevation.

### Clause 2.

The tissue digester of clause 1, wherein the second drain is in selective fluid communication with the second drain conduit.

### Clause 3.

The tissue digester of clause 2, wherein the second drain is in selective fluid communication with the second drain conduit via at least one of: a drain valve, a panel, a door.

### Clause 4.

The tissue digester of clause 1, wherein the second drain is in open fluid communication with the second drain conduit.

### Clause 5.

The tissue digester of clause 1, wherein the divider projects obliquely from the inner sidewall.

### Clause 6.

The tissue digester of clause 1, further comprising at least one fluid inlet for selectively providing fluid into the fluid container.

### Clause 7.

The tissue digester of clause 1, wherein the second drain conduit is in fluid communication with the first drain conduit.

### Clause 8.

The tissue digester of clause 1, wherein the first drain extends from a bottom wall of the fluid container.

### Clause 9.

The tissue digester of clause 1, wherein the selective fluid communication of the first drain and the first drain conduit is provided by a first drain valve.

### Clause 10.

The tissue digester of clause 1, wherein the second drain and the second drain conduit are associated with a second drain valve.

### Clause 11.

A tissue digester comprising:

a fluid container having an upper region and a lower region;

a first drain extending from within the fluid container at the lower region and in selective fluid communication with a first drain conduit; and

a second drain associated with the upper region of the fluid container and associated with a second drain conduit,

wherein fluid within the fluid container is permitted to exit the second drain only when at least a level of the fluid at the second drain is at least at an elevation of the second drain.

### Clause 12.

The tissue digester of clause 11, further comprising:

a trough associated with the upper region and having a dividing wall extending upwards at least from a first elevation to a second elevation at a top of the upper region, wherein the second drain extends from within the trough,

wherein fluid within the fluid container is permitted to enter the trough thereby to cause the level of the fluid at the second drain to be at least at the elevation of the second drain only when a level of the fluid in the fluid container exceeds the second elevation.

### Clause 13.

The tissue digester of clause 11, wherein the second drain is in selective fluid communication with the second drain conduit.

### Clause 14.

The tissue digester of clause 13, wherein the second drain is in selective fluid communication with the second drain conduit via at least one of: a drain valve, a panel, a port.

### Clause 15.

The tissue digester of clause 11, wherein the second drain is in open fluid communication with the second drain conduit.

### Clause 16.

The tissue digester of clause 12, wherein the trough comprises an inner sidewall of the fluid container and the dividing wall projects from the inner sidewall from the first elevation to the second elevation.

### Clause 17.

The tissue digester of clause 12, wherein the trough comprises an outer sidewall of the fluid container and the dividing wall is the outer sidewall.

### Clause 18.

The tissue digester of clause 12, wherein the trough is on the inside of the fluid container.

### Clause 19.

The tissue digester of clause 12, wherein the trough is on the outside of the fluid container.

### Clause 20.

The tissue digester of clause 11, further comprising at least one fluid inlet for selectively providing fluid into the fluid container.

### Clause 21.

The tissue digester of clause 11, wherein the second drain conduit is in fluid communication with the first drain conduit.

### Clause 22.

The tissue digester of clause 11, wherein the first drain extends from a bottom wall of the fluid container.

### Clause 23.

The tissue digester of clause 11, wherein the selective fluid communication of the first drain and the first drain conduit is provided by a first drain valve.

### Clause 24.

The tissue digester of clause 11, wherein the selective fluid communication of the second drain and the second drain conduit is provided by a second drain valve.

### Clause 25.

A method of operating the tissue digester of any one of clauses 1 to 10, 12, and 16 to 19, the method comprising:

initiating a tissue digestion by submerging at least remains within an alkaline liquid within the fluid container, wherein a fluid level of the alkaline liquid and resulting effluent during the tissue digestion remains below the second elevation;

after at least some tissue digestion, causing the fluid level of the effluent to rise to above the second elevation thereby to permit an upper stratum of the effluent to enter into the trough; and

after permitting the upper stratum of the effluent to enter into the trough, draining a remainder of the effluent via the first drain.

### Clause 26.

The method of clause 25, further comprising:
draining the upper stratum of the effluent via the second drain.

### Clause 27.

The method of clause 26, wherein draining the upper stratum of the effluent via the second drain comprises draining the upper stratum of the effluent via the second drain simultaneously with the draining of a remainder of the effluent via the first drain.

### Clause 28.

The method of clause 26, wherein draining the upper stratum of the effluent via the second drain comprises draining the upper stratum of the effluent via the second drain before the draining of a remainder of the effluent via the first drain.

### Clause 29.

The method of clause 26, wherein draining the upper stratum of the effluent via the second drain comprises draining the upper stratum of the effluent via the second drain after the draining of a remainder of the effluent via the first drain.

### Clause 30.

The method of clause 25, wherein a liquid level of the alkaline liquid and the resulting effluent during the tissue digestion remains below the first elevation.

### Clause 31.

A method of operating the tissue digester of any one of clauses 11 and 13 to 15, the method comprising:

initiating a tissue digestion by submerging at least remains within an alkaline liquid within the fluid container thereby to produce an effluent;

after at least some tissue digestion, causing an upper stratum of the effluent to enter into the second drain; and

after permitting the upper stratum of the effluent to enter into the second drain, draining a remainder of the effluent via the first drain.

### Clause 32.

The method of clause 31, wherein a liquid level of the alkaline liquid and the resulting effluent during the tissue digestion remains below the elevation of the second drain, wherein causing the upper stratum of the effluent to enter into the second drain comprises:

causing the fluid level of the effluent to rise to at least the elevation of the second drain.

What is claimed is:

1. A tissue digester comprising:
a fluid container having an upper region and a lower region;
a first drain extending from within the fluid container at the lower region and in selective fluid communication with a first drain conduit;
a second drain extending from within the fluid container at the upper region and associated with a second drain conduit; and
a divider within the fluid container projecting from an inner sidewall of the fluid container from a first elevation at or beneath that of the second drain to a second elevation above the second drain thereby to form, with the inner sidewall, a trough,
wherein fluid within the fluid container is permitted to enter the trough thereby to exit the second drain only when at least a level of the fluid in the fluid container exceeds the second elevation.

2. The tissue digester of claim 1, wherein the second drain is in selective fluid communication with the second drain conduit.

3. The tissue digester of claim 2, wherein the second drain is in selective fluid communication with the second drain conduit via at least one of: a drain valve, a panel, a door.

4. The tissue digester of claim 1, wherein the second drain is in open fluid communication with the second drain conduit.

5. The tissue digester of claim 1, wherein the divider projects obliquely from the inner sidewall.

6. The tissue digester of claim 1, further comprising at least one fluid inlet for selectively providing fluid into the fluid container.

7. The tissue digester of claim 1, wherein the second drain conduit is in fluid communication with the first drain conduit.

8. The tissue digester of claim 1, wherein the first drain extends from a bottom wall of the fluid container.

9. The tissue digester of claim 1, wherein the selective fluid communication of the first drain and the first drain conduit is provided by a first drain valve.

10. The tissue digester of claim 1, wherein the second drain and the second drain conduit are associated with a second drain valve.

11. A tissue digester comprising:
a fluid container having an upper region and a lower region;
a first drain extending from within the fluid container at the lower region and in selective fluid communication with a first drain conduit; and
a second drain associated with the upper region of the fluid container and associated with a second drain conduit,
wherein fluid within the fluid container is permitted to exit the second drain only when at least a level of the fluid at the second drain is at least at an elevation of the second drain.

12. The tissue digester of claim 11, further comprising:
a trough associated with the upper region and having a dividing wall extending upwards at least from a first elevation to a second elevation at a top of the upper region, wherein the second drain extends from within the trough,
wherein fluid within the fluid container is permitted to enter the trough thereby to cause the level of the fluid at the second drain to be at least at the elevation of the second drain only when a level of the fluid in the fluid container exceeds the second elevation.

13. The tissue digester of claim 11, wherein the second drain is in selective fluid communication with the second drain conduit.

14. The tissue digester of claim 13, wherein the second drain is in selective fluid communication with the second drain conduit via at least one of: a drain valve, a panel, a port.

15. The tissue digester of claim 11, wherein the second drain is in open fluid communication with the second drain conduit.

16. The tissue digester of claim 12, wherein the trough comprises an inner sidewall of the fluid container and the dividing wall projects from the inner sidewall from the first elevation to the second elevation.

17. The tissue digester of claim 12, wherein the trough comprises an outer sidewall of the fluid container and the dividing wall is the outer sidewall.

18. The tissue digester of claim 12, wherein the trough is on the inside of the fluid container.

19. The tissue digester of claim 12, wherein the trough is on the outside of the fluid container.

20. The tissue digester of claim 11, further comprising at least one fluid inlet for selectively providing fluid into the fluid container.

21. The tissue digester of claim 11, wherein the second drain conduit is in fluid communication with the first drain conduit.

22. The tissue digester of claim 11, wherein the first drain extends from a bottom wall of the fluid container.

23. The tissue digester of claim 11, wherein the selective fluid communication of the first drain and the first drain conduit is provided by a first drain valve.

24. The tissue digester of claim 11, wherein the selective fluid communication of the second drain and the second drain conduit is provided by a second drain valve.

25. A method of operating a tissue digester, the tissue digester comprising a fluid container having an upper region and a lower region; a first drain extending from within the fluid container at the lower region and in selective fluid communication with a first drain conduit; a second drain extending from within the fluid container at the upper region and associated with a second drain conduit; and a divider within the fluid container projecting from an inner sidewall of the fluid container from a first elevation at or beneath that of the second drain to a second elevation above the second drain thereby to form, with the inner sidewall, a trough, wherein fluid within the fluid container is permitted to enter the trough thereby to exit the second drain only when at least a level of the fluid in the fluid container exceeds the second elevation,
the method comprising:
initiating a tissue digestion by submerging at least remains within an alkaline liquid within the fluid container, wherein a fluid level of the alkaline liquid and resulting effluent during the tissue digestion remains below the second elevation;
after at least some tissue digestion, causing the fluid level of the effluent to rise to above the second elevation thereby to permit an upper stratum of the effluent to enter into the trough; and
after permitting the upper stratum of the effluent to enter into the trough, draining a remainder of the effluent via the first drain.

26. The method of claim 25, further comprising:
draining the upper stratum of the effluent via the second drain.

27. The method of claim 26, wherein draining the upper stratum of the effluent via the second drain comprises draining the upper stratum of the effluent via the second drain simultaneously with the draining of a remainder of the effluent via the first drain.

28. The method of claim 26, wherein draining the upper stratum of the effluent via the second drain comprises draining the upper stratum of the effluent via the second drain before the draining of a remainder of the effluent via the first drain.

29. The method of claim 26, wherein draining the upper stratum of the effluent via the second drain comprises draining the upper stratum of the effluent via the second drain after the draining of a remainder of the effluent via the first drain.

30. The method of claim 25, wherein a liquid level of the alkaline liquid and the resulting effluent during the tissue digestion remains below the first elevation.

31. A method of operating a tissue digester, the tissue digester comprising a fluid container having an upper region and a lower region; a first drain extending from within the fluid container at the lower region and in selective fluid communication with a first drain conduit; and a second drain associated with the upper region of the fluid container and associated with a second drain conduit, wherein fluid within the fluid container is permitted to exit the second drain only when at least a level of the fluid at the second drain is at least at an elevation of the second drain,
the method comprising:
initiating a tissue digestion by submerging at least remains within an alkaline liquid within the fluid container thereby to produce an effluent;
after at least some tissue digestion, causing an upper stratum of the effluent to enter into the second drain; and
after permitting the upper stratum of the effluent to enter into the second drain, draining a remainder of the effluent via the first drain.

32. The method of claim 31, wherein a liquid level of the alkaline liquid and the resulting effluent during the tissue digestion remains below the elevation of the second drain, wherein causing the upper stratum of the effluent to enter into the second drain comprises:
causing the fluid level of the effluent to rise to at least the elevation of the second drain.
